(19) United States
(12) Patent Application Publication
(10) Pub. No.: US 2014/0099968 A1
(43) Pub. Date: Apr. 10, 2014

(54) METHOD FOR SCHEDULING USERS IN A CELLULAR ENVIRONMENT, SCHEDULER AND WIRELESS NETWORK

(71) Applicant: NTT DOCOMO, Inc., Tokyo (JP)

(72) Inventors: Harald BURCHARDT, Munich (DE); Sinan SINANOVIC, Munich (DE); Harald HAAS, Munich (DE); Guenther AUER, Munich (DE)

(73) Assignee: NTT DOCOMO, Inc., Tokyo (JP)

(21) Appl. No.: 14/106,017

(22) Filed: Dec. 13, 2013

Related U.S. Application Data
(63) Continuation of application No. PCT/EP2012/061338, filed on Jun. 14, 2012.

(30) Foreign Application Priority Data
Jun. 16, 2011 (EP) 11170114.0-2411

(51) Int. Cl. H04W 72/12; H04W 52/24

(52) U.S. Cl. CPC H04W 72/1231; H04W 52/241
USPC 455/452.2

(57) ABSTRACT

A method for scheduling users in a cellular environment such that a Pareto optimal power control can be applied, includes determining whether a set of users in the cellular environment fulfills a feasibility condition for the Pareto optimal power control, and in case the feasibility condition for the Pareto optimal power control is not fulfilled, modifying the SINR targets of the users such that the feasibility condition for the Pareto optimal power control is fulfilled.

### RELATED APPLICATIONS

This application is a continuation of PCT/EP2012/061338 filed on Jun. 14, 2012, which claims priority to the European Application No. 11170114.0-2411 filed on Jun. 16, 2011. The entire contents of these applications are incorporated herein by reference.

### BACKGROUND OF THE INVENTION

Embodiments of the invention relate to the field of wireless communication networks like cellular or heterogeneous networks composed of micro-cells, pico-cells and femto-cells specifically to joint scheduling and power control in a femto-cellular environment, in particular to a variation of user signal-to-interference-plus noise ratio (SINR) targets such that Pareto optimal power control (POPC) can be directly applied.

When considering scheduling and power control in the uplink of a cellular or heterogeneous network, e.g. composed of micro-cells, pico-cells and femto-cells, uplink power control is an important aspect and is particularly relevant for densely deployed femto-cell networks, due to their unplanned deployment and the resulting severe interference conditions. FIG. 1 is a schematic representation of a portion of such a cellular network comprising two base stations Rx₁ and Rx₂ receiving on the uplink connection signals from mobile stations or mobile users Tx₁ and Tx₂. Mobile stations Tx₁ communicate with base station Rx₁, while mobile station Tx₂ communicates with base station Rx₂. As shown in FIG. 1, several transmissions occur concurrently so that interference may occur. In the example shown in FIG. 1 the transmission signal transmitted by mobile station Tx₂ for communicating with the associated base station Rx₂ is also received at the base station Rx₁ as an interference transmission I₂₁. Interference may severely affect the attainable spectral efficiency in the network. Therefore, for avoiding negative effects on the spectral efficiency scheduling and power control in the uplink are important aspects. It is noted that the same applies for a downlink connection in such a network in which a transmission occurs from the respective base stations to the associated users, wherein a transmission from a base station may also be received as an interference communication at other mobile stations. When considering FIG. 1, in the downlink scenario the base stations would be in the transmitters Tx₁, Tx₂ and the mobile stations would be the receivers Rx₁ and Rx₂.

In X. Li, L. Qian, and D. Kataria, “Downlink power control in co-channel macrocell femtocell overlay,” in Proc. Conference on Information Sciences and Systems (CISS), 2009, pp. 383-388, and B.-G. Choi, E. S. Cho, M. Y. Chung, K.-Y. Cheon, and A.-S. Park, “A femtocell power control scheme to mitigate interference using listening tdd frame,” in Proc. International Conference on Information Networking (ICOIN), January 2011, pp. 241-244, downlink power control mechanisms are described to prevent large co-channel interference (CCI) from a femto-base station (BS) at nearby macro-users. In X. Li, et. al. the downlink power control problem is formulated to address CCI, while quality of service requirements for both the macro- and femto-users are taken into account. This is in contrast to B.-G. Choi, et. al., where macro-cell users are given priority; a listening time-dimension duplex frame is utilized to estimate the channel quality information of the surrounding macro-users, and hence adjust the femto-BS downlink transmit power accordingly. Both known solutions deal with interference reduction to the macro-cell in the downlink, whereas any uplink femto-femto interference is disregarded.

In E. J. Hong, S. Y. Yun, and D.-H. Cho, “Decentralized power control scheme in femtocell networks: A game theoretic approach,” in Proc. Personal, Indoor and Mobile Radio Communications (PIMRC), 2009, pp. 415-419, an approach for managing downlink interference between femto-cells and the macro-cell is described. A proportional fair metric is used to minimize interference and improve throughput fairness, however through this the overall system throughput suffers. A further solution to the uplink power control problem is the use of conventional and/or fractional power control as described in A. Rao, “Reverse Link Power Control for Managing Inter-Cell Interference in Orthogonal Multiple Access Systems,” in Proc. Of Vehicular Technology Conference (VTV), October 2007, pp. 1837-1841. However, these procedures are developed for the macro-cellular environment and do not guarantee quality of service.

### SUMMARY OF THE INVENTION

According to an embodiment, a method for scheduling users in a cellular environment such that a Pareto optimal power control can be applied may have the steps of: determining whether a set of users in the cellular environment fulfills a feasibility condition for the Pareto optimal power control; and in case the feasibility condition for the Pareto optimal power control is not fulfilled, modifying the SINR targets of the users such that the feasibility condition for the Pareto optimal power control is fulfilled, wherein modifying the SINR targets includes: identifying the one or more users that account for the largest contribution to the non-fulfillment of the feasibility condition for the Pareto optimal power control; diminishing the respective SINR targets of the one or more users; and augmenting the respective SINR targets of the remaining users to maintain system spectral efficiency, and wherein the feasibility condition is as follows:

F₁₂F₂₁+F₁₃F₃₁+F₂₃F₃₂+F₁₂F₂₃F₃₁+F₁₃F₂₁F₃₂<1,

where

$${F}_{ij} = \frac{{γ}_{i}^{*} {G}_{j , {v}_{i}}}{{G}_{i , {v}_{i}}}$$

are the elements of the interference matrix F,

γᵢ* is the target SINR of user i, and

G_{j,v}_{ᵢ} is the path gain between user j and the BS vᵢ of user i.

Another embodiment may have a computer program product having instructions to perform the inventive method when executing the instructions on a computer.

Another embodiment may have a scheduler for a wireless network having a plurality of cells and a plurality of users, the scheduler being configured to schedule the users in accordance with the inventive method.

Another embodiment may have a wireless network having a plurality of cells, a plurality of users, and an inventive scheduler.

Embodiments of the invention provide a method for scheduling users in a cellular environment such that a Pareto optimal power control can be applied, the method comprising:

determining whether a set of users in the cellular environment fulfills a feasibility condition for the Pareto optimal power control; and

in case the feasibility condition for the Pareto optimal power control is not fulfilled, modifying the SINR targets of the users such that the feasibility condition for the Pareto optimal power control is fulfilled.

Embodiments of the invention provide a scheduler for a wireless network having a plurality of cells and a plurality of users, the scheduler being configured to schedule the users in accordance with embodiments of the invention.

Embodiments of the invention provide a wireless network comprising a plurality of cells, a plurality of users, and a scheduler in accordance with embodiments of the invention.

Yet another embodiment of the invention provides a computer program product comprising a program including instructions stored by a computer readable medium, the instructions executing a method in accordance with embodiments of the invention when running the program on a computer.

In accordance with an embodiment modifying the SINR targets comprises iterating through combinations of increased and decreased SINR target for the users until a combination of SINR target for the users is found fulfilling the feasibility condition for the Pareto optimal power control.

In accordance with an embodiment modifying the SINR targets comprises identifying the one or more users that account for the largest contribution to the non-fulfillment of the feasibility condition for the Pareto optimal power control; diminishing the respective SINR targets of the one or more users; and augmenting the respective SINR targets of the remaining users to maintain system spectral efficiency. The respective SINR targets of the one or more users are diminished as follows:

$${γ}_{i}^{*} ← {γ}_{i}^{*} ( 1 - r )$$

$${γ}_{j}^{*} ← {γ}_{j}^{*} ( 1 - r )$$

$$where r = ⌈ ( 1 - \frac{1}{f ( F )} ) \cdot 10 ⌉ \cdot \frac{1}{10 \cdot {n}_{r}} ,$$

where
γᵢ* is the target SINR of user i,
γⱼ* is the target SINR of user j,
r represents the SINR reduction factor rounded up to a factor of 0.1, and
nᵣ denotes the number of users whose SINR targets are being reduced; and
   the respective SINR targets of the remaining users may be augmented as follows:

$${γ}_{k \neq \{ i , j \}}^{*} = \frac{( 1 + {γ}_{1}^{*} ) ( 1 + {γ}_{2}^{*} ) ( 1 + {γ}_{3}^{*} )}{( 1 + {γ}_{i}^{*} ( 1 - r ) ) ( 1 + {γ}_{j}^{*} ( 1 - r ) )} - 1.$$

In accordance with an embodiment, in case modifying the SINR targets of the users does not result in the feasibility condition for the Pareto optimal power control to be fulfilled, the method further comprises deactivating the user having the weakest desired link gain; adapting a SINR target of the remaining users to maintain system spectral efficiency; determining whether the remaining users fulfill a modified feasibility condition; and in case the remaining users do not fulfill the modified feasibility condition, iteratively modifying the SINR target values until the modified feasibility condition is fulfilled. In case the modified feasibility condition cannot be fulfilled by the users, the user having the best desired link gain may be chosen as the only remaining active link.

In accordance with an embodiment the feasibility condition is as follows:

F₁₂F₂₁+F₁₃F₃₁+F₂₃F₃₂+F₁₂F₂₃F₃₁+F₁₃F₂₁F₃₂<1

where

$${F}_{ij} = \frac{{γ}_{i}^{*} {G}_{j , {v}_{i}}}{{G}_{i , {v}_{i}}}$$

are the elements of the interference matrix F,

γᵢ* is the target SINR of user i, and

G_{j,v}_{ᵢ} is the path gain between user j and the BS vᵢ of user i.

In accordance with an embodiment the method further comprises, in case there are one or more users that prevent the satisfaction of the feasibility condition, switching off the associated links. The links may be switched off over a plurality of consecutive time slots, wherein the SINR target of the remaining links is changed for maintaining the system spectral efficiency. The SINR target of the remaining links may be changed as follows:

$${γ}_{( 1 ) , up}^{*} = \frac{{\prod }_{j}^{K} ( 1 + {γ}_{j}^{*} )}{1 + {γ}_{( 2 ) , up}^{*}} - 1 ,$$

where γ_{(i),up}* represents the updated SINR target of the i^{th} remaining link.

In accordance with an embodiment the method comprises for each combination fulfilling the feasibility condition calculating the Pareto optimal power allocation and assigning it to the users.

In accordance with embodiments of the invention, Pareto optimal power control with SINR variation in a femto-cell system is provided using an approach called Pareto SINK scheduling (PSS) which is a novel scheduling mechanism based on Pareto optimal power control (POPC). The signal-to-interference-plus-noise ratio (SINR) targets of interfering mobile stations (MSs) are modified such that the conditions of POPC are fulfilled while system spectral efficiency is maintained. In accordance with embodiments, a step-wise removal (SR) algorithm is introduced for coping with situations where one or more links do not meet the sufficient conditions for the power control in accordance with POPC. In this case, one or more links are removed in order for the other MSs to achieve their SINR targets, while the targets of the other (remaining) MSs are updated to prevent losses in system spectral efficiency caused by the link removals.

Embodiments of the invention are applicable to cellular as well as heterogeneous networks composed of micro-, pico- and femto-cells.

Thus, embodiments of the invention address a relatively unexplored topic of uplink power control for randomly deployed femto-cells. It is noted that while embodiments of the invention are described with regard to the uplink power control the principles of the inventive approach can be equally implemented for downlink power control. Due to the relative modernity of the femto-cell concept and the innate random deployment of femto-cells within a macro-cell, most power control is utilized for interference reduction to the macro-cell, rather than interference protection between femto-cells. The inventive approach provides for a power control technique for such femto-femto interference environments which also helps diminishing interference to the macro-cell.

The inventive approach is advantageous as it jointly and simultaneously solves the issues of scheduling and power control for high density femto-cell deployments. Further, power usage of the femto-users is minimized due to POPC. The interference emanating from the femto-cell environment is minimized and hence the effects on a macro-cell are mitigated. The SINR variations may be modified over time such that each MS achieves its target spectral efficiency in multiple time slots. All scheduled users, i.e. users that have been assigned resource blocks (RBs) and have not been removed through SR, achieve their SINR targets, and hence also the system spectral efficiency target is achieved. Further, an enhanced sum-rate is achieved through an increase in spatial reviews. Also a proportional fair rate education can be implemented in accordance with which cell-center users are allowed to a higher SINR target (and therefore rate) than cell-edge users. Also energy efficiency is significantly improved through power control in accordance with the inventive approach.

### BRIEF DESCRIPTION OF THE DRAWINGS

Embodiments of the present invention will be detailed subsequently referring to the appended drawings, in which:

FIG. 1 is a schematic representation of a portion of a cellular network;

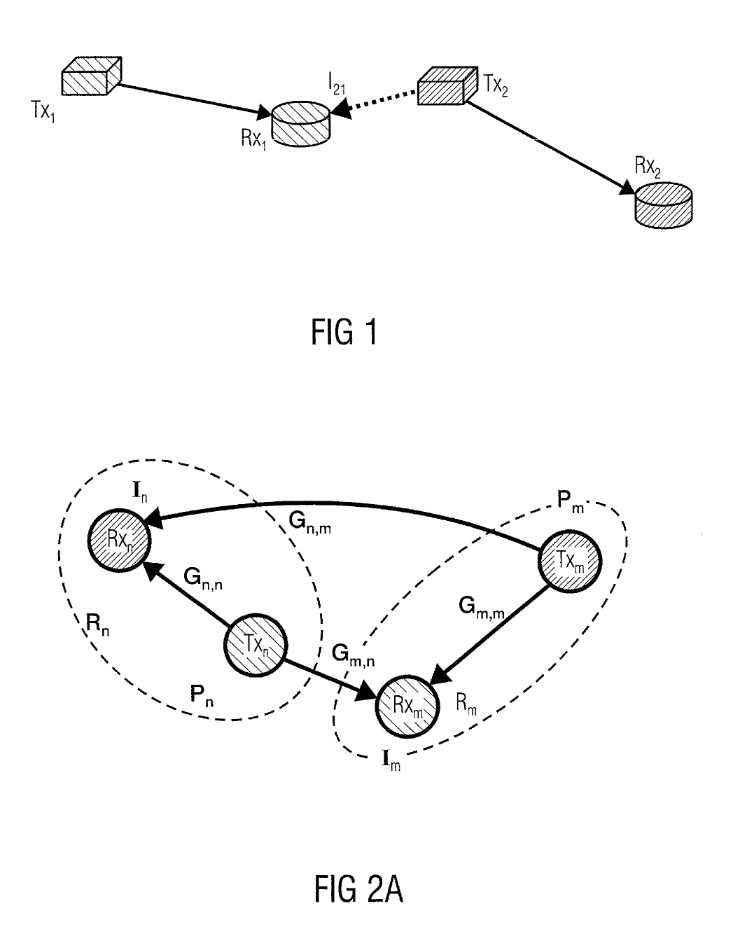

FIGS. 2A through 2C show schematic representations of a communication system, wherein FIG. 2A depicts a schematic representation of two transmitters, and wherein FIG. 2B and FIG. 2C depict the strengths of a receive signal, a noise signal and an interference signal at two receivers;

FIG. 3 is a schematic representation of a femto-cell deployment in an apartment block;

FIG. 4 shows an example of a SR algorithm with SINR target updates over multiple time slots;

FIG. 5 shows a graph depicting the range of values for c and d in equation (6) for which all eigenvalues of F are within the unit circle;

FIGS. 6A and 6B show the PSS algorithm in accordance with an embodiment of the invention;

FIG. 7 depicts the spectral efficiency results for various power allocation techniques over a range of representative SINR targets; and

FIG. 8 displays the average power usage of a system for various power allocation techniques.

### DETAILED DESCRIPTION OF THE PREFERRED EMBODIMENTS

PSS (Pareto SINR Scheduling) focuses on scheduling users such that POPC is applied, and hence system spectral efficiency and energy consumption are optimized. The inventive approach relies on POPC that is, for example, described in A. Goldsmith, Wireless Communications. Cambridge University Press, 2005. POPC allows all users to achieve the SINR targets and also allows minimizing the total transmit power of these mobile stations (MSs).

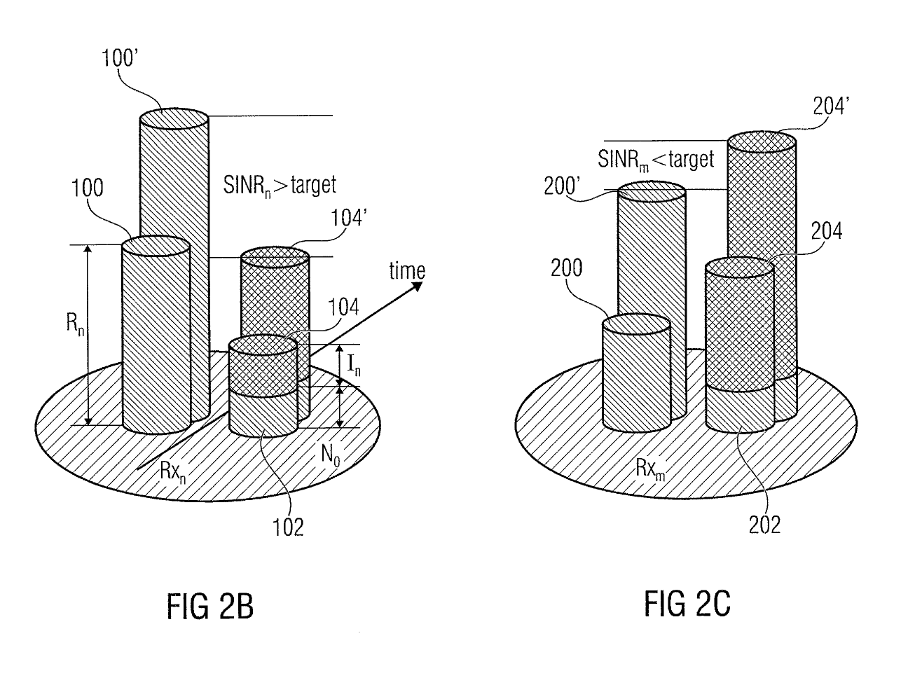

FIGS. 2A through 2C show schematic representations of a communication system. FIG. 2A depicts a schematic representation of two transmitters Txₙ and Txₘ transmitting signals. Further, two receivers Rxₙ and Rxₘ are shown receiving from the transmitters respective signals. In FIG. 2A the transmitter Txₙ serves the transmitter Rxₙ via a channel having a channel gain G_{n,n}. Likewise, the transmitters Txₘ serves the receiver Rxₘ via a further channel having a channel gain G_{m,m}. However, the respective receivers are also subjected to interference in that receiver Rxₙ receives a signal from the transmitter Txₘ, via an interference channel having a channel gain G_{n,m}. Likewise receiver Rxₘ receives a signal from the transmitter Txₙ via an interference channel having a channel gain G_{m,n}. The transmit powers of the respective transmitters are denoted as Pₙ and Pₘ, respectively, and the received power or rather the power level of the signal received at the respective receivers is denoted Rₙ and Rₘ, respectively. The SINR at receiver Rxₙ is calculated as follows:

$${γ}_{n} = \frac{{R}_{n}}{{I}_{n} + {N}_{0}}$$

The transmit power is set as follows:

P*=(I−F)⁻¹u iff ρ_{F}<1,

where:
P Tx power,
I identity matrix,
F interference matrix with

$${F}_{ij} = \frac{{γ}_{i}^{*} {G}_{j , {v}_{i}}}{{G}_{i , {v}_{i}}} ,$$

u vector of the noise power scaled by the SINR targets and channel gains,
ρ_{F} largest eigenvalue of F,
Gᵢ channel gain; and
γᵢ* SINR target.

However, increasing the transmit power on one link induces interferences to the other link as is shown in FIGS. 2B and 2C. In FIG. 2B the received power 100 (Rₙ(k)) at a time instance k is indicated. Also the noise signal 102 (N₀) and the interference signal 104 (Iₙ) at time instance k are shown. In FIG. 2C the received power 200 at receiver Rxₘ at instance k, the noise signal 202 (N₀) and the interference signal 204 at the receiver Rxₘ is shown at time instance k. The distance between the transmitter Txₙ and the receiver Rxₘ is smaller than a distance between the transmitter Txₘ and the receiver Rxₙ. The distance between the transceiver Txₙ and the receiver Rxₙ is shorter than a distance between the transmitter Txₘ and the receiver Rxₘ. The power received at receiver Rxₙ is higher than the power received at receive Rxₘ (see FIG. 2B and FIG. 2C). The noise remains substantially unchanged. Further, the interference signal at the receiver Rxₙ is smaller than the interference signal 204 at the receiver Rxₘ.

In case it is determined that a desired SINR is not achieved at receiver Rxₘ, and the transmitter Txₘ may be controlled to increase its transmit power as is shown at 200′ in FIG. 2C. However, this, in turn yields a higher interference signal and the receiver Rxₙ as is shown at 104′ in FIG. 2B. Further, in case the transmit power of the transmitter Txₙ is increased as is shown at 100′ in FIG. 2B, for example for obtaining a desired SINR at receiver Rxₙ this also increases the interference experienced by the receiver Rxₘ as is shown at 200′. As can be seen from FIG. 2B and from FIG. 2C, when increasing the transmit power it may be that at the receiver Rxₘ the increased reception power 100′ results in a SINR that is greater than the SINR target, while an increase of the transmit power of transmitter Txₘ will still result in a SINR at the receiver Rxₘ that is below the desired target. The problem with Pareto optimal power control is that the SINR target γᵢ*, in general, is a predefined constant value so that it does not reflect the interference and channel conditions, and also does not take into consideration that cell-edge users typically achieve a much lower SINR than cell-center users.

Embodiments of the invention address this problem and provide for an approach allowing to apply Pareto optimal power control also in such environments. In accordance with the inventive approach to allow applying POPC the SINR targets of femto-interferers are varied in such a manner that POPC can be applied directly to the interfering MSs. For allowing POPC to be applied to a group of interfering MSs, the following condition has to hold:

P*=(I−F)⁻¹u iff ρ_{F}<1, (1)

where P* is the Pareto optimum power vector, I is the identity matrix, u is the vector of noise power scaled by the SINR targets and channel gains, F is the interference matrix, and ρ_{F} is the Perron-Frobenius (i.e., maximum absolute) eigenvalue of F. If a group of MSs interfering with each other can fulfill the condition in equation (1), then POPC is utilized and each MS is allocated in optimum transmit power. To be able to schedule users in this way, the condition set forth in equation (1) needs to be formulated such that the network can directly utilize available information, i.e., path gains and SINR targets. After a derivation, the feasibility condition can be formulated as follows:

F₁₂F₂₁+F₁₃F₃₁+F₂₃F₃₂+F₁₂F₂₃F₃₁+F₁₃F₂₁F₃₂<1, (2)

where

$${F}_{ij} = \frac{{γ}_{i}^{*} {G}_{j , {v}_{i}}}{{G}_{i , {v}_{i}}}$$

are the elements of the interference matrix F,

γᵢ* is the target SINR of MS i, and

G_{j,v}_{ᵢ} is the path gain between MS j and the BS vᵢ of MS i.

Thus, the feasibility condition is expressed in terms of path gains and SINR targets, and the users can be scheduled accordingly.

A key component of PSS is the variation of users' SINR targets when the condition in Eq. (2) is not satisfied for the given SINR requirements. After identifying the MS(s) that account for the largest contribution to ƒ(F)>1, the respective SINR targets of these users are diminished in accordance:

$${γ}_{i}^{*} ← {γ}_{i}^{*} ( 1 - r ) \\ {γ}_{j}^{*} ← {γ}_{j}^{*} ( 1 - r ) \\ where r = ⌈ ( 1 - \frac{1}{f ( F )} ) \cdot 10 ⌉ \cdot \frac{1}{10 \cdot {n}_{r}} , \qquad ( 3 )$$

wherein the SINR target of the (in this case) single remaining user is augmented in order to maintain system spectral efficiency

$${γ}_{k \neq \{ i , j \}}^{*} = \frac{( 1 + {γ}_{1}^{*} ) ( 1 + {γ}_{2}^{*} ) ( 1 + {γ}_{3}^{*} )}{( 1 + {γ}_{i}^{*} ( 1 - r ) ) ( 1 + {γ}_{j}^{*} ( 1 - r ) )} - 1. \qquad ( 4 )$$

Through this SINR variation, ƒ(F) can be reduced, and the users can be scheduled to transmit simultaneously.

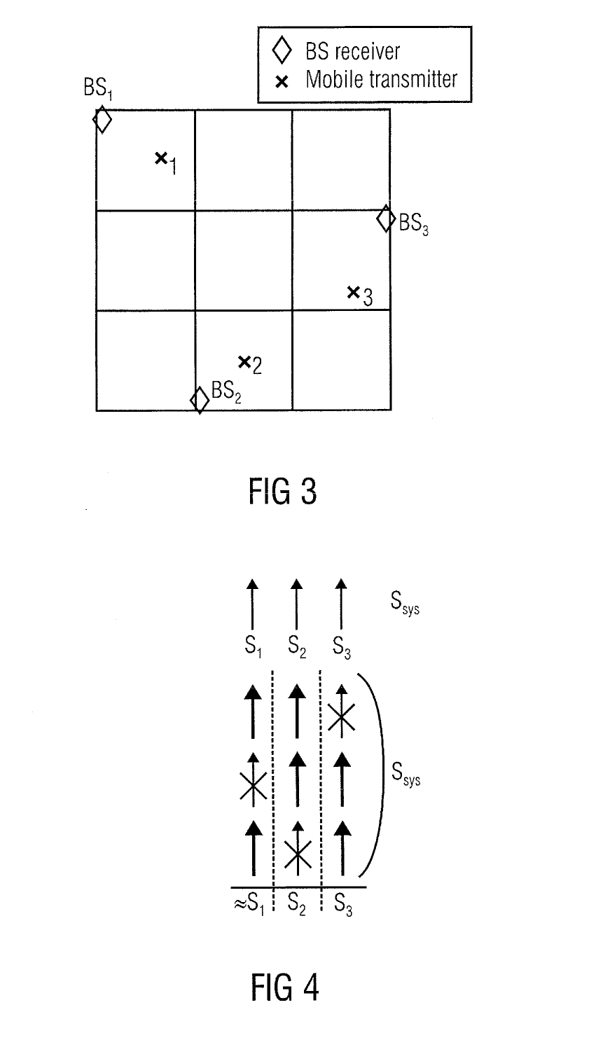

FIG. 3 is a schematic representation of a femto-cell deployment in an apartment block. FIG. 3 shows three base stations BS₁, BS₂, and BS₃ as well as three mobile stations x₁, x₂, and x₃. FIG. 3, thus, shows, three femto-cells C₁, C₂, and C₃. In accordance with embodiments of the invention, it is assumed that one user is provided per cell and that the interfering path gains are fixed. In accordance with the inventive approach, a Pareto optimal power control with a variable SINR target is provided wherein the SINR targets of the respective users are varied so as to achieve ρ_{F}<1 which allows for serving more links simultaneously and also for taking into account the channel conditions of particular users.

In accordance with an embodiment, an algorithm for Pareto optimal power control with several SINR targets comprises as a first step a power control step for determining whether the above mentioned feasibility condition is met, i.e. whether ρ_{F} is small than 1. In case this is not true, in a second step a SINR target adjustment takes place for reducing the SINR target γᵢ* of the weakest link and increasing the SINR target of the other links so that the spectral efficiency is maintained. In case it is determined that still the feasibility condition is not met, at least one of the links that does not achieve the SINR target is removed until the feasibility condition is met. This will be described in further detail below.

Considering again the femto-cell deployment shown in FIG. 3, it is assumed that only a single MS per femto-cell is present so that the interfering path gains are fixed. Hence, if the feasibility conditions or sufficient conditions for POPC are not met, the SINR targets of the users will be varied to achieve ρ_{F}<1. This is done by identifying the strongest interfering MS(s) and reducing the corresponding SINR target(s), while increasing the remaining target(s) to maintain system spectral efficiency. If it is possible to schedule the users in the system such that condition (2) is fulfilled, then with POPC every user will achieve its target SINR and the total system power will be minimized.

An example of such a scheduling instance is shown in FIG. 3 in which the three femto-cells C₁-C₃ within the apartment interfere with each other. The initial SINR targets of the mobile stations x₁-x₃ are not compatible for simultaneous transmission. After identifying the main culprits for the infeasibility of the scenario, in the example shown it is assumed that mobile stations x₂ and x₃ are not compatible, in accordance with the inventive approach (BSs) the SINR targets are updated in accordance with Eqs. (3) and (4) such that the new targets allow for all users x₁-x₃ to be scheduled. This allows using POPC and after POPC is applied, each mobile station will achieve its SINR target with Pareto optimal transmit power.

For example, when considering FIG. 3, initially the SINR targets of the mobile stations x₁-x₃ are as follows:

(γ₁*,γ₂*,γ₃*)=(10,12,8), and

ƒ(F)≈1.35, r=0.15.

Thus, the initial SINR targets did not fulfill the feasibility condition, i.e. ƒ(F) is greater than 1. Thus, POPC could not be applied. In accordance with the inventive approach, the SINR targets of the mobile stations x₁-x₃ are updated using PSS, more specifically on the basis of Eqs. (3) and (4). This results in updated SINR targets for mobile stations x₁-x₃ as follows:

(γ₁*,γ₂*,γ₃*)←(13.7,10.2,6.8), and

ƒ(F)≈0.92.

Thus, the feasibility condition for allowing the use of POPC is met and all mobile stations shown in FIG. 3 can now be scheduled.

Scheduling may take place either in the respective base stations BS₁-BS₃ communicating with each other via a backbone network or in an entity at a higher level in the network, for example in the base station of the macro-cell.

In accordance with embodiments, some mobile stations may be at a position preventing the satisfaction of the condition for POPC. For example, such mobile stations may be arranged at the cell-edge. In such embodiments, these links need to be switched off in order to allow the other femto-cell users to be scheduled and achieve their SINR targets. In addition, because turning off any link may harm the system spectral efficiency, the SINR targets of the other MSs need to be updated to cover the removed spectral efficiency from the excluded user. Through this mechanism, POPC may still be applied with a link (or multiple links if needed) removed, thereby maintaining spectral efficiency and allowing for a minimum transmit power usage.

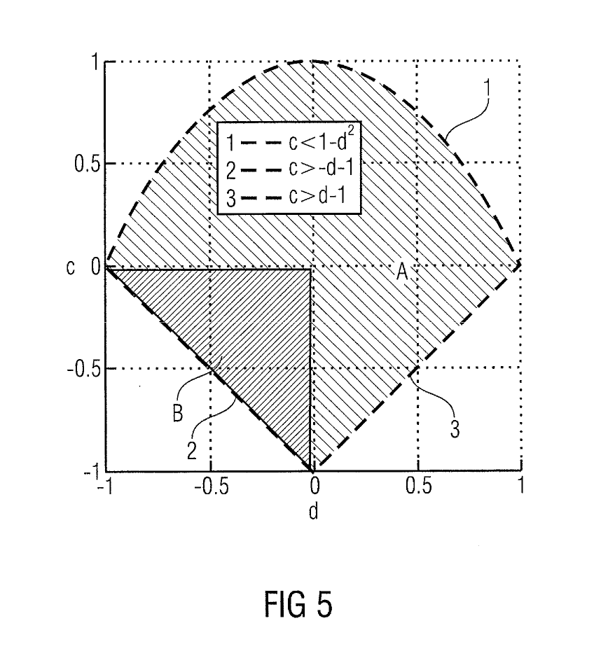

An example of the SR algorithm is shown in FIG. 4 with SINR target updates over multiple time slots. As is shown in FIG. 4, over multiple time slots S₁ to S₃ for a mobile station each of the three links is removed once, as is shown by the dashed arrow having the x. At the same time, the SINR targets (and consequently the spectral efficiency) of the two remaining links are augmented as is indicated by larger, bold arrows. By this approach, in each time slot and over all time slots (in the example shown over three time slots) the spectral efficiency S_{sys} is maintained. Furthermore, over three time slots each individual MS can achieve its target spectral efficiency, because the two inflated transmissions compensate for the loss of the removed transmission. Hence, both the system and the individual spectral efficiencies are maintained through the SINR target updates in the SR algorithm, while the link removals in each slot allow for scheduling of the other two users.

In the following, embodiments of the inventive approach will be described in further detail. In Pareto optimal power allocation, given a feasible link allocation, i.e., ρ_{F}<1, a vector P*=(I−F)⁻¹u can be found such that all users achieve their SINR requirements with minimal power. This is a highly desirable result which, depending on the locations and SINR targets of the interfering MSs, may not be possible. Hence, by adjusting the SINR targets of the interferers in such a manner as to create a feasible F matrix, the system spectral efficiency can be maximized. A scheduler in accordance with embodiments of the invention allowing for this will now be described.

Since for a group of MSs to be feasible ρF<1, it follows the modulus of all eigenvalues λi of F also has to be less than unity, i.e., |λᵢ∥<1, ∀i=1, . . . , K. In other words, all eigenvalues have to lie within the unit circle.

In E. Jury, “A simplified stability criterion for linear discrete systems,” Proceedings of the IRE, vol. 50, no. 6, pp. 1493-1500, 1962, a simplified analytic test of stability of linear discrete systems is described. The test also yields the necessitated and sufficient conditions for any real polynomial to have all its roots inside the unit circle. Hence, this test can be directly applied to the characteristic function ƒ_{F}(λ) of the matrix F, whose roots are the eigenvalues of F, and thus need to lie within the unit circle. The characteristic function of F, ƒ_{F}, can be expressed as follows:

$$\begin{matrix} Given F = [ \begin{matrix}0 & {F}_{12} & {F}_{13} \\ {F}_{21} & 0 & {F}_{23} \\ {F}_{31} & {F}_{32} & 0\end{matrix} ] \\ \begin{matrix}{f}_{{F}_{3}} ( λ ) = det ( F - λ I ) \\ = 0 \\ = - {λ}^{3} + λ ( {F}_{12} {F}_{21} + {F}_{13} {F}_{31} + {F}_{23} {F}_{32} ) + {F}_{12} {F}_{23} {F}_{31} + {F}_{13} {F}_{21} {F}_{32} \\ = {λ}^{3} + c λ + d\end{matrix} & ( 5 ) \\ Hence \text{:} c = - {F}_{12} {F}_{21} - {F}_{13} {F}_{31} - {F}_{23} {F}_{32} \\ d = - {F}_{12} {F}_{23} {F}_{31} - {F}_{13} {F}_{21} {F}_{32} & ( 6 )\end{matrix}$$

In E. Jury, “A simplified stability criterion for linear discrete systems,” Proceedings of the IRE, vol. 50, no. 6, pp. 1493-1500, 1962, the stability constraints for a polynomial of order K=3 are given as:

ƒ(z)=a₃z³+a₂z²+a₁z+a₀, a₃>0

1) |a₀|<a₃

2) a₀²−a₃²<a₀a₂−a₁a₃

3) a₀+a₁+a₂+a₃>0,a₀−a₁+a₂<a₃<0 (7)

In E. Jury, “A simplified stability criterion for linear discrete systems,” Proceedings of the IRE, vol. 50, no. 6, pp. 1493-1500, 1962, the stability constraints are for a polynomial of degree n to have all its n roots within the unit circle, which is a necessitated condition for the stability of linear discrete systems. However, in accordance with the inventive approach the stability of the polynomial is not an issue, rather it is to be ensured that the roots, which are the eigenvalues of F, lie within the unit circle so that F becomes feasible.

The above conditions can now be applied to the characteristic function θ_{F}_{₃}(λ)

ƒ_{F}_{₃}(λ)=λ³+cλ+d

a₃=1,a₂=0,a₁=c,a₀=d,

1) |d|<1

2) d²−1<c→c>1−d²

3) d+c+1>0→c>−d−1,

d−c−1<0→c>d−1 (8)

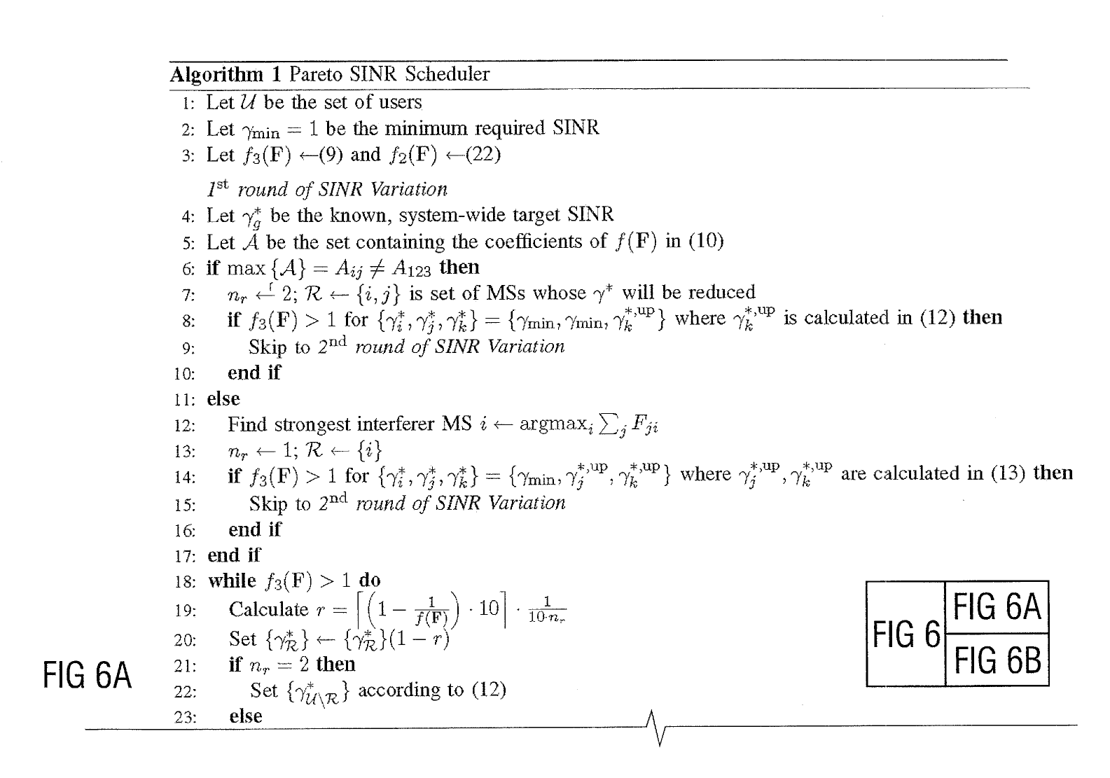

which describes the ranges of c and d for which F is feasible. These are shown in FIG. 5 by the dotted lines and the enclosed area. In FIG. 5 the enclosed area depicts the range of values for c and d in equation (6) for which all eigenvalues of F are within the unit circle. Due to the nature of c, d<0, the area B within the dotted lines 1, 2 and 3 denotes a specific feasibility area. However, since F_{i,j}>0,∀i,j, it is clear that both c, d<0, and hence the feasible area is substantially reduced (from the area A to the area B in FIG. 5), and the constraints are reduced to only a single one, such that the feasibility condition becomes:

3) c>−d−1

−F₁₂F₂₁+F₁₃F₃₁+F₂₃F₃₂>F₁₂F₂₃F₃₁+F₁₃F₂₁F₃₂−1,

So, ρ_{F}<1 if:

F₁₂F₂₁+F₁₃F₃₁+F₂₃F₃₂+F₁₂F₂₃F₃₁+F₁₃F₂₁F₃₂<1. (9)

In the following the SINR variation in accordance with embodiments of the invention will be described. The feasibility condition given in (9) can be re-written as

$$\begin{matrix}f ( F ) = {F}_{12} {F}_{21} + {F}_{13} {F}_{31} + {F}_{23} {F}_{32} + {F}_{12} {F}_{23} {F}_{31} + {F}_{13} {F}_{21} {F}_{32} < 1 \\ = {γ}_{1}^{*} {γ}_{2}^{*} ( {ρ}^{2} \frac{{G}_{1 , {v}_{2}} {G}_{2 , {v}_{1}}}{{G}_{1 , {v}_{1}} {G}_{2 , {v}_{2}}} ) + {γ}_{1}^{*} {γ}_{3}^{*} ( {ρ}^{2} \frac{{G}_{1 , {v}_{3}} {G}_{3 , {v}_{1}}}{{G}_{1 , {v}_{1}} {G}_{3 , {v}_{3}}} ) + \\ {γ}_{2}^{*} {γ}_{3}^{*} ( {ρ}^{2} \frac{{G}_{2 , {v}_{3}} {G}_{3 , {v}_{2}}}{{G}_{2 , {v}_{2}} {G}_{3 , {v}_{3}}} ) + \\ {γ}_{1}^{*} {γ}_{2}^{*} {γ}_{3}^{*} ( {ρ}^{3} \frac{{G}_{1 , {v}_{2}} {G}_{2 , {v}_{3}} {G}_{3 , {v}_{1}} + {G}_{1 , {v}_{3}} {G}_{2 , {v}_{1}} {G}_{3 , {v}_{2}}}{{G}_{1 , {v}_{1}} {G}_{2 , {v}_{2}} {G}_{3 , {v}_{3}}} ) \\ = {γ}_{1}^{*} {γ}_{2}^{*} {A}_{12} + {γ}_{1}^{*} {γ}_{3}^{*} {A}_{13} + {γ}_{2}^{*} {γ}_{3}^{*} {A}_{23} + {γ}_{1}^{*} {γ}_{2}^{*} {γ}_{3}^{*} {A}_{123}\end{matrix} \qquad ( 10 )$$

where A={A₁₂,A₁₃,A₂₃,A₁₂₃} is the set of coefficients of ƒ that are constant throughout the SINR variation. Therefore if ƒ(F)>1, by finding max {A} the largest coefficient can be found, and hence the SINR targets preceding the coefficient can be reduced to ultimately decrease ƒ(F). This is described in the following.

Given ƒ(F)>1 and max{A}=Aᵢⱼ, γᵢ*, and γⱼ*; need to be reduced such that ƒ(F)<1. The reduction is performed as follows:

$$r = ⌈ ( 1 - \frac{1}{f ( F )} ) \cdot 10 ⌉ \cdot \frac{1}{10 \cdot {n}_{r}} \\ {γ}_{i}^{*} ← {γ}_{i}^{*} ( 1 - r ) \\ {γ}_{j}^{*} ← {γ}_{j}^{*} ( 1 - r ) \qquad ( 11 )$$

where r in (11) represents the SINR reduction factor rounded up to a factor of 0.1 (this is accomplished by

$$[ \cdot ⌈ 10 ⌉ \cdot \frac{1}{10} ] ;$$

the reason for this rounding is two-fold: firstly, since ƒ(F) has to be <1, without the rounding ƒ(F) would be steered towards 1 and not below; secondly, the SINR increase of the third user will again slightly increase ƒ(F), and nᵣ denotes the number of MSs whose SINR targets are being reduced (in the above case, nᵣ=2). To maintain the desired system spectral efficiency however, the remaining user's SINR target has to be increased, which is done quite simply

$${γ}_{k \neq \{ i , j \}}^{*} = \frac{( 1 + {γ}_{1}^{*} ) ( 1 + {γ}_{2}^{*} ) ( 1 + {γ}_{3}^{*} )}{( 1 + {γ}_{i}^{*} ( 1 - r ) ) ( 1 + {γ}_{j}^{*} ( 1 - r ) )} - 1. \qquad ( 12 )$$

Through this, the system spectral efficiency is maintained while the value of ƒ(F) is decreased. This procedure, although it may achieve the desired SINR target constellation by the first reduction/increase, is repeated until either γᵢ*, γⱼ*≦γₘᵢₙ, or ƒ(F)<1 (this will become evident in the algorithm described n further detail below).

For the (rather unlikely) case that max{A}=A₁₂₃, the strongest interferer MS i is found (i.e., as in the Stepwise Removal algorithm it is the column of F with the largest sum), and the same reduction is performed except nᵣ=1 in (11). The SINR target increase of the remaining MS is then performed as

$${γ}_{\{ j , k \} \neq i}^{*} = \sqrt{\frac{( 1 + {γ}_{1}^{*} ) ( 1 + {γ}_{2}^{*} ) ( 1 + {γ}_{3}^{*} )}{( 1 + {γ}_{i}^{*} ( 1 - r ) )}} - 1. \qquad ( 13 )$$

In both POPC and the Foschini-Miljanic algorithm (an iterative implementation of POPC and described in A. Goldsmith, Wireless Communications University Press 2005), if ρ_{F} [symbol] 1 then no solution is available, and hence P→0 or P→(Pₘₐₓ, . . . , Pₘₐₓ)^{T}, respectively. In these cases, either none of the links will transmit, or transmit with (most-likely) too much power, and hence these solutions are suboptimal.

To address this problem is to successively remove single links from the group of interfering MSs, until an F is achieved with ρ_{F}<1. At each step, the link is removed that is causing the largest interference to the other users, i.e., the column of F with the largest sum (both the column and the corresponding row are removed from F). However, turning off one of the links will harm the system spectral efficiency, and hence, in accordance with embodiments, an update function is provided to amend the SINR targets of the remaining links such that the system spectral efficiency does not suffer:

$${γ}_{( 1 ) , up}^{*} = \frac{{\prod }_{j}^{K} ( 1 + {γ}_{j}^{*} )}{1 + {γ}_{( 2 ) , up}^{*}} - 1 , \qquad ( 14 )$$

where γ_{(i),up}* represents the updated SINR target of the i^{th} remaining link. Since equation (14) has infinite solutions, an additional condition on γ_{(1),up}* and γ_{(2),up}* such as a power minimization

Solve(14)s.t. min {γ_{(1),up}*+γ_{(2),up}*}, (15)

or an equal absolute SINR increase

Solve (14) s.t. γ_{(1),up}*−γ₍₁₎*=γ_{(2),up}*−γ₍₂₎*, (16)

is necessitated. Finally, when two links have been removed and only a single link remains,

$${γ}_{( 1 ) , up}^{*} = {\prod }_{j}^{K} ( 1 + {γ}_{j}^{*} ) - 1 \\ and F = 0 , {ρ}_{F} = 0 , and P = u = \frac{n {γ}_{( 1 ) , up}^{*}}{{G}_{1 , {v}_{1}}} . \qquad ( 17 )$$

Through this form of link removal, the system spectral efficiency can be maintained while maximizing the number of transmitting users according to the feasibility constraint ρ_{F}. Furthermore, it prevents the explosion of transmit powers that results from the Foschini-Miljanic algorithm, and the annihilation of links caused by POPC.

In the case that the scheduler is unable to find feasible groups for particular MSs (due to e.g., location at cell-edge), the SR algorithm will turn off one of the links in a group of MSs, resulting in a feasibility matrix F of size K−1×K−1, in the three-cell case 2×2:

$$F = [ \begin{matrix}0 & {F}_{12} \\ {F}_{21} & 0\end{matrix} ] \qquad ( 18 )$$

Hence, the characteristic function is given by

$$\begin{matrix}{f}_{{F}_{2}} ( λ ) = det ( F - λ I ) \\ = {λ}^{2} - {F}_{12} {F}_{21} \\ = 0 \\ = {λ}^{2} + c\end{matrix} \\ c = - {F}_{12} {F}_{21} \qquad ( 19 )$$

Again from E. Jury, “A simplified stability criterion for linear discrete systems,” Proceedings of the IRE, vol. 50, no. 6, pp. 1493-1500, 1962, the stability constraints for a polynomial of order K−1=2 are

ƒ(z)=a₂z²+a₁z+a₀, a₂>0

1) |a₀|<a₂

2) a₀+a₁+a₂>0, a₀−a₁+a₂>0 (20)

Applying these conditions to the ƒ_{F}_{₂}(λ) yields

ƒ_{F}_{₂}(λ)=λ²+c

a₂=1,a₁=0,a₀=c,

1) |c|<1

2) c+1>0→1>c, (21)

and hence the feasibility condition is given by

2)_{1>F}_{₁₂}_{F}_{₂₁}^{1>-c} So, ρ_{F}<1 if: F₁₂F₂₁<1. (22)

If, now, the feasibility condition (22) is not satisfied, the SINR target of the MS i with the weaker desired channel gain will be reduced according to (11) with nᵣ=1, while MS j with the stronger desired link receives a SINR target boost according to

$${γ}_{j}^{*} = \frac{( 1 + {γ}_{i}^{*} ) ( 1 + {γ}_{j}^{*} )}{1 + {γ}_{i}^{*} ( 1 - r )} - 1 , \qquad ( 23 )$$

to maintain the system spectral efficiency (the MS with the stronger desired link is chosen for the SINR target boost as it will necessitate less power than the weaker MS to achieve it due to its enhanced desired channel gain, and hence causes less interference). This is again repeated until either γᵢ*<γₘᵢₙ, or ƒ(F)<1.

Finally, if the scheduler is unable to find {γᵢ*,γⱼ*}≧γₘᵢₙ such that F becomes feasible, the MS with the weaker desired link is removed, and the SINR target of the remaining user is updated according to (17).

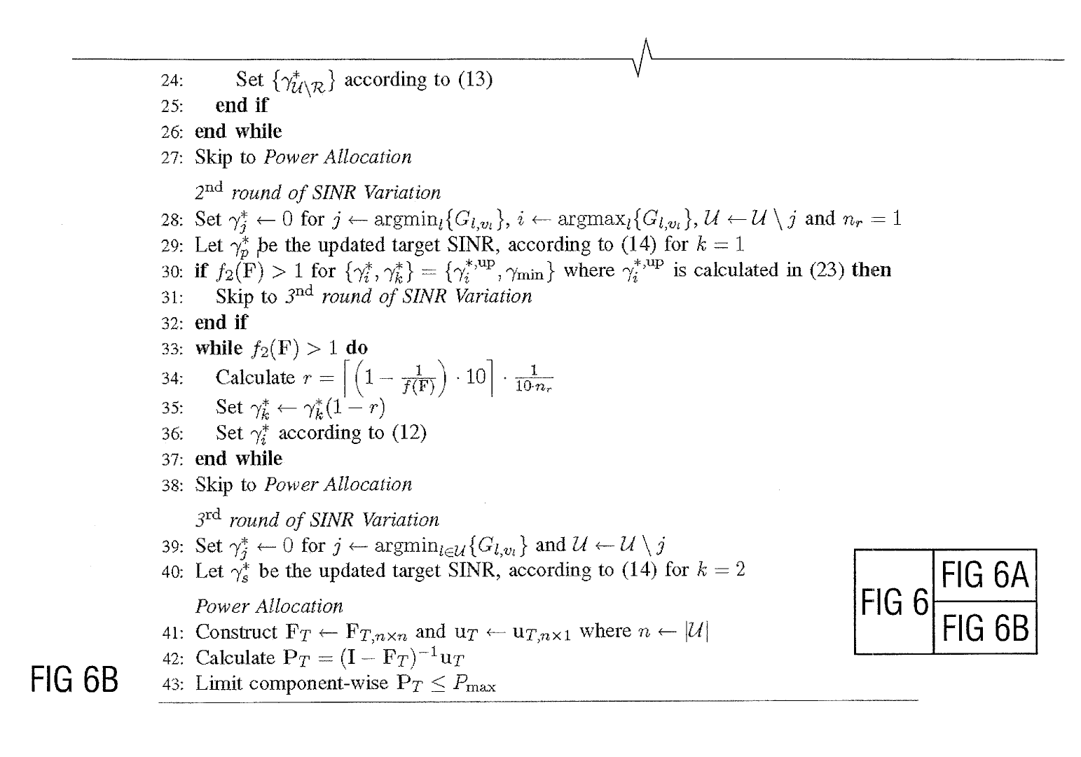

An embodiment of the PSS algorithm or scheduler is shown in FIG. 6 and will now be described. The focus of PSS is on femto-cellular networks, and hence on a single user per cell. In PSS, the target SINR of the individual users are modified in order to find a feasible F matrix, and hence a Pareto optimal system.

In the first part of the scheduler, all three links are active, and the feasibility of F is tested using (9). If this is >1, then the SINR targets need to be varied. In equation (10), ƒ(F) is expressed in terms of the γ*'s and the set of constant coefficients A. By finding max{A}, and reducing the γ*'s of which it is the coefficient, the value of ƒ(F) should decrease (this is because the multiplier for the largest coefficient, i.e., that which has the most effect on ƒ(F), is being reduced, and hence the overall value of ƒ(F) should also decrease). This is repeated until ƒ(F)<1. In the case, however, that a feasible F is not achievable with all γ*>γₘᵢₙ (this is checked before anyhow in the if statements prior to the while loop), then a link needs to be turned off in order to maintain a minimum SINR at each MS, as well as be able to maintain the spectral efficiency. This is done in the second round of SINR variation.

In the second part of the algorithm depicted in FIG. 6, the feasibility condition ƒ(F) is now (22), and the MS j with the weakest desired link gain is removed (i.e., γⱼ*=0). The SINR targets of both remaining users are updated by (14). Again, a check is performed whether the remaining two links can form a feasible F matrix given that the weaker SINR target >γₘᵢₙ. If this is the case, then the same SINR reduction is performed on the MS with the weaker desired link, whereas the other active MS receives an SINR target boost given in (23). This is iterated until ƒ(F)<1.

The third round of SINR variation is entered only if the feasibility checks on the first two rounds failed. In this case, the user with the best desired link gain is chosen as the only remaining active link, with a target SINR determined by (17). Then, the final part of the scheduler performs the power allocation to the users using POPC. Of course, if particular links have been turned off during the scheduling process, this is taken into account. In the end, providing the transmit power of the active MS is not limited by Pₘₐₓ, the scheduler will deliver the targeted system spectral efficiency, while minimizing the system power.

In the following a proof for the convergence of ƒ(F) by the SINR variations (11) and (12) implemented in the above described algorithm will be provided.

The proof is based on the check condition implemented in the algorithm in lines 6-17 (see FIGS. 6A and 6B), where the SINR variation is not even performed if ƒ(F)>1 for {γᵢ*, γⱼ*, γₖ*}={γₘᵢₙ, γₘᵢₙ, γₖ^{*,up}}. Thus, the convergence of the variation algorithm can be expressed as in the following Theorem:

Given ƒ(F)≡ƒ(Γ)>1, where Γ=(γᵢ, γⱼ, γₖ), then iterative variations of Γ according to equations (11) and (12) will converge to ƒ(Γ)<1 if

f(Γₘᵢₙ)<1 for Γₘᵢₙ=(γₘᵢₙ, γₘᵢₙ, γₖ^{up})

where γₖ^{up} is updated to maintain spectral efficiency.

Proof: Given that ƒ(Γ)>1, γᵢ and γⱼ are updated iteratively as follows

γᵢ^{(m+1)}←γᵢ^{(m)}(1−r^{(m)})

γⱼ^{(m+1)}←γⱼ^{(m)}(1−r^{(m)})

where r is calculated by (11), m=0, 1, 2, . . . , and if ƒ(F)>1 then 0<r^{(m)}<1, and (1−r^{(m)})<1. Hence, as long as ƒ(Γ)>1, γᵢ and γⱼ will continue to be reduced (upper-bounded by the geometric sequence of γᵢ(1−minₘ{r^{(m)}})^{m})

γᵢ⁽ⁿ⁾←γₘᵢₙ

γⱼ⁽ⁿ⁾←γₘᵢₙ

and hence Γ=Γₘᵢₙ=(γₘᵢₙ, γₘᵢₙ, γₖ^{up}), where γₖ^{up} is determined by (12) (due to the calculation of r in equation (11), γᵢ⁽ⁿ⁾, γⱼ⁽ⁿ⁾ will most likely become smaller than γₘᵢₙ; however in this case, they are simply set to γₘᵢₙ (as they should not go lower anyway), and γₖ^{up} is calculated accordingly). Therefore, if f(Γₘᵢₙ)<1, then the algorithm will eventually enter this region (see FIG. 5) where ƒ(F)=ƒ(Γ)>1, and therefore the algorithm will converge.

The theorem and the corresponding proof also apply to max{A}=A₁₂₃, where nᵣ=1 in equation (11) and Γₘᵢₙ=(γₘᵢₙ, γⱼ^{up}, γₖ^{up}). Furthermore, it can also be applied to K−1=2, where Γₘᵢₙ=(γₘᵢₙ, γⱼ^{up}), and hence the algorithm converges in all of these cases.

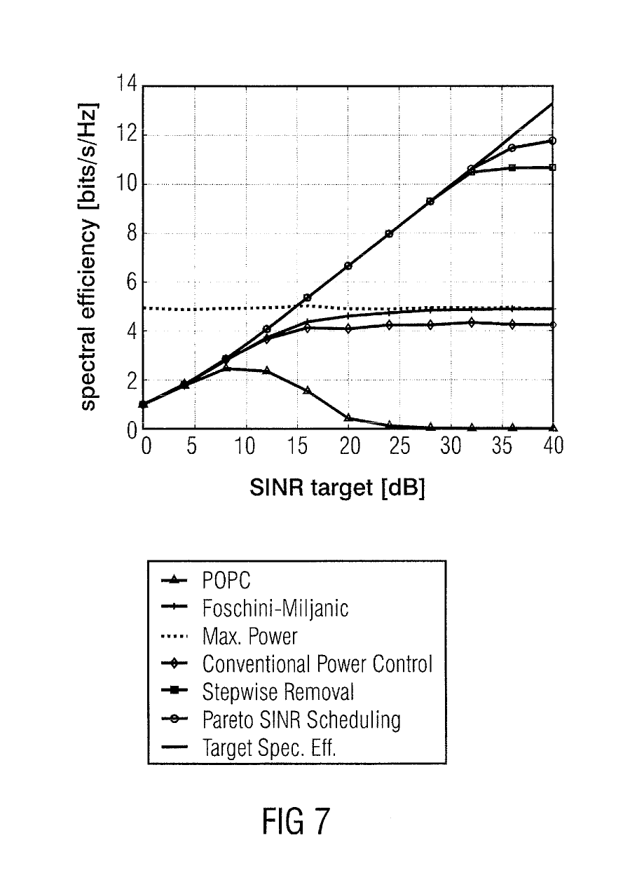

FIG. 7 depicts the spectral efficiency results for the various power allocation techniques over a range of representative SINR targets. As expected, the Foschini-Miljanic solution converges towards the maximum power system, while the POPC spectral efficiency performance converges to 0 bits/s/Hz already at γ*_{sys}=12 dB due to the infeasibility of the F matrix for large SINR. Through the removal of links in the Stepwise Removal algorithm and PSS, these are able to maintain the system spectral efficiency target up to γ*_{sys}=12 dB, at which point the scheduling benefits of PSS become evident, gaining approximately 1 bit/s/Hz at 40 dB. It is evident that PSS outperforms all other techniques for the scenario investigated.

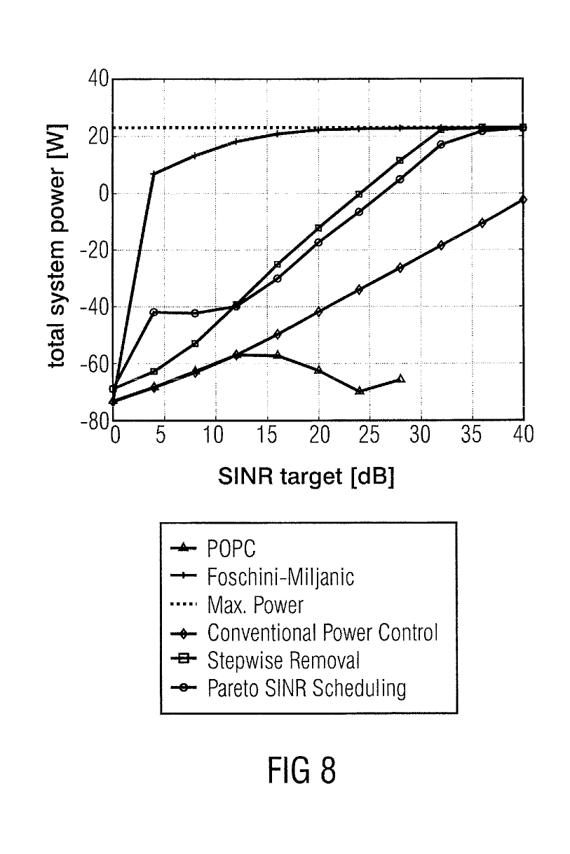

FIG. 8 displays the average power usage of the system for the various power allocation techniques. The convergence of the Foschini-Miljanic algorithm to a maximum power system can be seen, whereas both the Stepwise Removal algorithm and the F-SINR scheduler converge to a third of this value (i.e., a single active MS transmitting at Pₘₐₓ). Here, PSS is able to use slightly less power, on average, as it allows more active users, and hence these do then not need to satisfy as high a SINR target through the updates by (14). Further, POPC transmits with nearly no power at all, as it either transmits optimally (i.e., when the original F is feasible) or not at all (i.e., when F is infeasible). All in all, however, it is again evident that PSS manages to minimize system power while satisfying the SINR requirements of the users.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed. Generally, embodiments of the present invention can be implemented as a computer program product with a program code, the program code being operative for performing one of the methods when the computer program product runs on a computer. The program code may for example be stored on a machine readable carrier. Other embodiments comprise the computer program for performing one of the methods described herein, stored on a machine readable carrier. In other words, an embodiment of the inventive method is, therefore, a computer program having a program code for performing one of the methods described herein, when the computer program runs on a computer. A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein. A further embodiment comprises a computer having installed thereon the computer program for performing one of the methods described herein. In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A method for scheduling users in a cellular environment such that a Pareto optimal power control can be applied, the method comprising:
determining whether a set of users in the cellular environment fulfills a feasibility condition for the Pareto optimal power control; and
in case the feasibility condition for the Pareto optimal power control is not fulfilled, modifying the SINR targets of the users such that the feasibility condition for the Pareto optimal power control is fulfilled,
wherein modifying the SINR targets comprises:
identifying the one or more users that account for the largest contribution to the non-fulfillment of the feasibility condition for the Pareto optimal power control;
diminishing the respective SINR targets of the one or more users; and
augmenting the respective SINR targets of the remaining users to maintain system spectral efficiency, and
wherein the feasibility condition is as follows:
F₁₂F₂₁+F₁₃F₃₁+F₂₃F₃₂+F₁₂F₂₃F₃₁+F₁₃F₂₁F₃₂<1
where
$${F}_{ij} = \frac{{γ}_{i}^{*} {G}_{j , {v}_{i}}}{{G}_{i , {v}_{i}}}$$
are the elements of the interference matrix F,
γᵢ* is the target SINR of user i, and
G_{j,v}_{ᵢ} is the path gain between user j and the BS vᵢ of user i.

2. The method of claim 1, wherein
the respective SINR targets of the one or more users are diminished as follows:
$$\begin{matrix}{γ}_{i}^{*} ← {γ}_{i}^{*} ( 1 - r ) \\ {γ}_{j}^{*} ← {γ}_{j}^{*} ( 1 - r )\end{matrix} where r = ⌈ ( 1 - \frac{1}{f ( F )} ) \cdot 10 ⌉ \cdot \frac{1}{10 \cdot {n}_{r}} ,$$
where
γᵢ* is the target SINR of user i,
γⱼ* is the target SINR of user j,
r represents the SINR reduction factor rounded up to a factor of 0.1, and
nᵣ denotes the number of users whose SINR targets are being reduced; and
the respective SINR targets of the remaining users are augmented as follows:
$${γ}_{k \neq \{ i , j \}}^{*} = \frac{( 1 + {γ}_{1}^{*} ) ( 1 + {γ}_{2}^{*} ) ( 1 + {γ}_{3}^{*} )}{( 1 + {γ}_{i}^{*} ( 1 - r ) ) ( 1 + {γ}_{j}^{*} ( 1 - r ) )} - 1.$$

3. The method of claim 1, wherein, in case modifying the SINR targets of the users does not result in the feasibility condition for the Pareto optimal power control to be fulfilled, the method further comprises:
deactivating the user with the weakest desired link gain;
adapting a SINR target of the remaining users to maintain system spectral efficiency;
determining whether the remaining users fulfill a modified feasibility condition; and
in case the remaining users do not fulfill the modified feasibility condition, iteratively modifying the SINR target values until the modified feasibility condition is fulfilled.

4. The method of claim 3, wherein in case the modified feasibility condition cannot be fulfilled by the users, the user with the best desired link gain is chosen as the only remaining active link.

5. The method of claim 1, further comprising:
in case there are one or more users that prevent the satisfaction of the feasibility condition, switching off the associated links.

6. The method of claim 5, wherein the links are switched off over a plurality of consecutive time slots, wherein the SINR target of the remaining links is changed for maintaining the system spectral efficiency.

7. The method of claim 6, wherein the SINR target of the remaining links is changed as follows:
$${γ}_{( 1 ) , up}^{*} = \frac{{\prod }_{j}^{K} ( 1 + {γ}_{j}^{*} )}{1 + {γ}_{( 2 ) , up}^{*}} - 1 ,$$
where γ_{(i),up}* represents the updated SINR target of the i^{th} remaining link.

8. The method of claim 1, comprising for each combination fulfilling the feasibility condition:
calculating the Pareto optimal power allocation and assigning it to the users.

9. A computer program product comprising instructions to perform a method of claim 1 when executing the instructions on a computer.

10. A scheduler for a wireless network comprising a plurality of cells and a plurality of users, the scheduler being configured to schedule the users in accordance with claim 1.

11. A wireless network comprising a plurality of cells, a plurality of users, and a scheduler of claim 10.
